(19) United States
(12) Patent Application Publication
(10) Pub. No.: US 2026/0109144 A1
(43) Pub. Date: Apr. 23, 2026

(54) METHOD OF MANUFACTURING VACUUM INSULATION MATERIAL

(71) Applicant: HYUNDAI TRANSYS INC., Seosan-si (KR)

(72) Inventors: Ho Sub LIM, Hwaseong-si (KR); Hwa Jun LEE, Hwaseong-si (KR); Jong Chan LEE, Hwaseong-si (KR); Hye Ju YOO, Hwaseong-si (KR)

(21) Appl. No.: 19/341,051

(22) Filed: Sep. 26, 2025

(30) Foreign Application Priority Data
Oct. 23, 2024 (KR) 10-2024-0145595

(51) Int. Cl. B32B 38/00; B32B 37/10

(52) U.S. Cl. CPC B32B 38/0012; B32B 37/1018; B32B 2597/00

(57) ABSTRACT

The present disclosure relates to a method of manufacturing a vacuum insulation material. The method includes a wire bonding step of providing a wire bonding structure by bonding a metal wire disposed in a given pattern to a core material thereby generating a processed core material comprising the wire, a core material separation step of separating the processed core material from the wire bonding structure, a sealing and vacuum treatment step of sealing and vacuum treating the processed core material by wrapping with a cladding material, and a vacuum insulation duct forming step of bending the processed core material wrapped with the cladding material by a sealing and vacuum treatment to form a vacuum insulation duct comprising at least one curved surface.

### CROSS-REFERENCE TO RELATED APPLICATION

This application claims, under 35 U.S.C. §119(a), priority to Korean Patent Application No. 10-2024-0145595 filed on October 23, 2024, the entire contents of which are incorporated herein by reference.

### BACKGROUND

### A Technical Field

The present disclosure relates to a method of manufacturing a vacuum insulation material, and more particularly to a method of manufacturing a vacuum insulation material capable of providing a vacuum insulation duct having a three-dimensional shape with a metal wire inserted therein to improve rigidity of the vacuum insulation material.

### Background Art

Generally, insulation materials configured to limit heat transfer are used in buildings, pipes, ice boxes, and other structures where there is a temperature difference between the interior and the exterior.

Such insulation materials may be broadly categorized into general insulation materials and vacuum insulation materials.

General insulation materials have a thermal conductivity of approximately 30 mW/mK, whereas vacuum insulation materials have a thermal conductivity of approximately 3 mW/mK to 10 mW/mK. Consequently, vacuum insulation materials have approximately 3 to 10 times higher insulation performance than general insulation materials.

Despite high insulation properties, vacuum insulation materials have not been widely used due to high material costs and difficulty in manufacturing.

Recently, with many advances in manufacturing technology, countries such as Germany, the United Kingdom, Japan, the United States, Canada, South Korea, and China have been working to commercialize vacuum insulation materials, but high material and manufacturing process costs remain a significant burden.

Meanwhile, ceiling materials used in vehicles are typically molded into felt or board forms and attached to the ceiling of a vehicle to block noise from entering the interior from the outside and to improve the insulation performance of the vehicle.

In the case of such ceiling materials for vehicles, conventionally, there is a problem such as insufficient thermal insulation effects against heat entering from the outside of a vehicle compared to the sound absorption or soundproofing performance against noise entering from the outside of the vehicle, and there is another problem such as damage due to weight or sagging due to warping caused by insufficient product rigidity.

The above information disclosed in this Background period is provided only for enhancement of understanding of the background of the present disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

It is an aspect of the present disclosure to provide a method of manufacturing a vacuum insulation material, wherein a metal wire disposed in a certain pattern is bonded to a plate-shaped core material, the core material is blanked using a press die to separate the core material in an unfolded shape, the top and the bottom of the core material in the unfolded shape are sealed with a cladding material and vacuum-treated, and bending is performed along the unfolded shape to form a vacuum insulation duct in a three-dimensional shape, thereby improving the rigidity of the vacuum insulation duct having the metal wire inserted therein by processing the vacuum insulation duct.

The aspects of the present disclosure are not limited to that described above. The aspects of the present disclosure will be clearly understood from the following description of embodiments and could be implemented by means defined in the claims and a combination thereof.

A method of manufacturing a vacuum insulation material according to an embodiment of the present disclosure includes a wire bonding step of providing a wire bonding structure by bonding a metal wire disposed in a given pattern to a core material thereby generating a processed core material comprising the wire, a core material separation step of separating the processed core material from the wire bonding structure, a sealing and vacuum treatment step of sealing and vacuum treating the processed core material by wrapping a cladding material, and a vacuum insulation duct forming step of bending the processed core material wrapped with the cladding material by a sealing and vacuum treatment to form a vacuum insulation duct comprising at least one curved surface.

In the wire bonding step, the wire along with a frame may be bonded to the core material while the wire is fixed and the given pattern of the wire is maintained by way of the frame.

In the core material separation step, the processed core material in an unfolded shape may be separated from the wire bonding structure by blanking.

In the vacuum insulation duct forming step, the processed core material wrapped with the cladding material may be bent along the unfolded shape to form the vacuum insulation duct.

In the sealing and vacuum treatment step, sealing and vacuum treatment may be performed to the top and the bottom of the processed core material that are facing the cladding material such that the exterior and the interior of the vacuum insulation duct are wrapped by the cladding material.

The method of manufacturing the vacuum insulation material according to the embodiment of the present disclosure may further include a cover mounting step of mounting a cover, processed to correspond in shape to the vacuum insulation duct, to an exterior of the vacuum insulation duct.

A method of manufacturing a vacuum insulation material according to another embodiment of the present disclosure includes a wire forming step of forming a metal wire into a duct shape including at least one curved surface so as to form a duct-shaped wire, a core material bonding step of bonding a core material to the exterior of the duct-shaped wire so as to wrap around the wire, a cladding material fitting step of fitting a cladding material on the interior and the exterior of the duct-shaped wire wrapped by the core material, and a vacuum insulation duct forming step of sealing and vacuum treating the cladding material to form a vacuum insulation duct.

The method of manufacturing the vacuum insulation material according to the other embodiment of the present disclosure may further include a cover mounting step of mounting a cover processed to correspond in shape to the vacuum insulation duct to an exterior of the vacuum insulation duct.

Other aspects and preferred embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are views showing a method of manufacturing a vacuum insulating material according to an embodiment of the present disclosure in sequence;

FIG. 3 is a view showing the structure of a frame in the method of manufacturing the vacuum insulating material according to the embodiment of the present disclosure;

FIG. 4 is a view showing a cover mounting step in the method of manufacturing the vacuum insulating material according to the embodiment of the present disclosure; and

FIGS. 5 and 6 are views showing a method of manufacturing a vacuum insulating material according to another embodiment of the present disclosure in sequence.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, positions, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, preferred embodiments of the present disclosure will be described in detail with reference to the accompanying drawings.

Advantages and features of the present disclosure and methods for achieving the same will be clearly understood with reference to the following detailed description of embodiments in conjunction with the accompanying drawings.

However, the present disclosure is not limited to the embodiments disclosed herein and may be implemented in various different forms. The embodiments are merely given to make the disclosure of the present disclosure perfect and to perfectly instruct the scope of the disclosure to those skilled in the art, and the present disclosure should be defined by the scope of claims.

Furthermore, in describing the present disclosure, a detailed description of the related prior art will be omitted when the same may obscure the subject matter of the present disclosure.

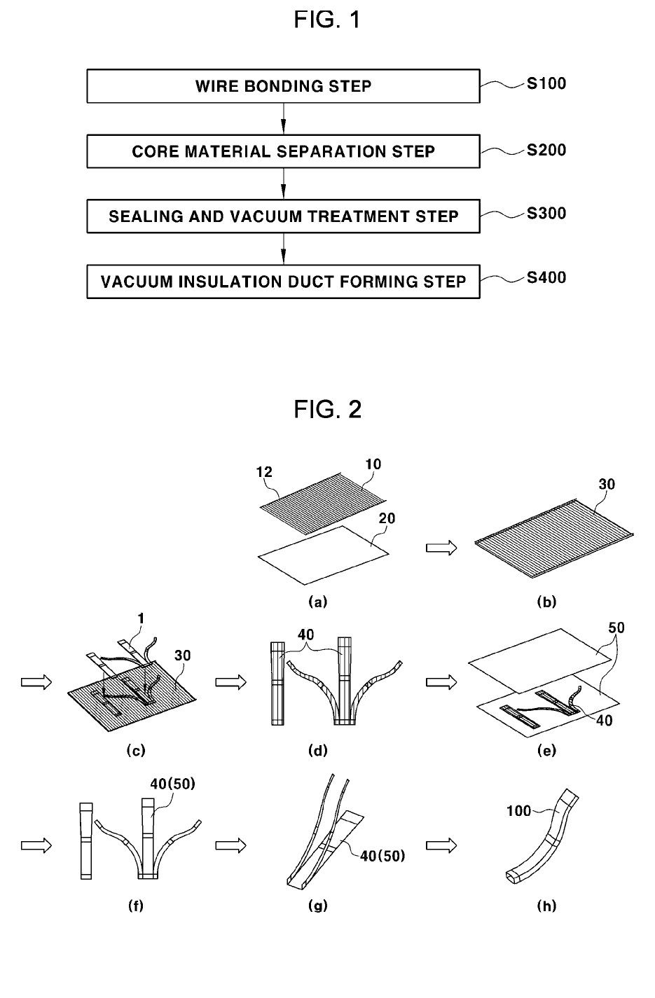

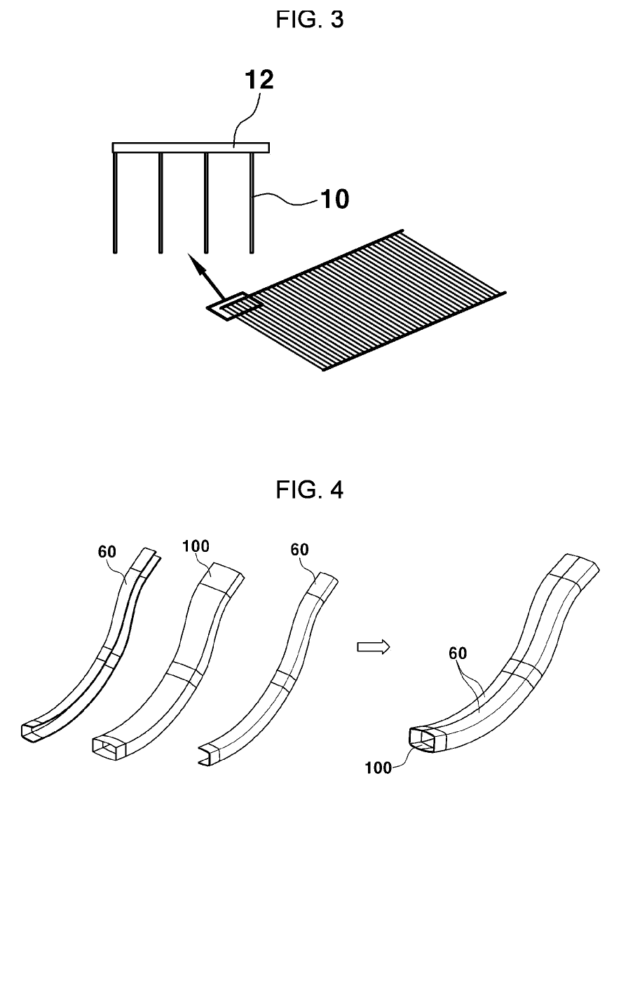

FIGS. 1 and 2 are views showing a method of manufacturing a vacuum insulating material according to an embodiment of the present disclosure in sequence, FIG. 3 is a view showing the structure of a frame in the method of manufacturing the vacuum insulating material according to the embodiment of the present disclosure, and FIG. 4 is a view showing a cover mounting step in the method of manufacturing the vacuum insulating material according to the embodiment of the present disclosure.

Generally, a vacuum insulation material is a high-efficiency insulation material with low thermal conductivity, and may be produced into various plate shapes by adjusting the size and thickness of a core material provided therein.

That is, a general vacuum insulating material may be manufactured by wrapping the top and the bottom of a porous core material cut into a plate shape with a thin sheet-shaped cladding material to seal the porous core material and performing vacuum treatment to form an internal vacuum space.

However, the main component of the core material is glass fiber, and the main component of the cladding material is aluminum, wherein both materials are prone to deformation and damage due to external force. This may lead to damage to the vacuum structure in the cladding material, resulting in a decrease in insulation performance, and therefore it is necessary to ensure the rigidity of the vacuum insulation material.

In addition, due to limitations in forming technology, the core material and the cladding material can only be formed into plate-like shapes, making it difficult to realize three-dimensional shapes such as a duct.

In the present embodiment, a core material 20 including a metal wire 10 is prepared in order to enhance rigidity of the vacuum insulation material and to form the vacuum insulation material into three-dimensional shapes. Since the core material 20 is processed in an unfolded shape, a vacuum insulating material, such as a vacuum insulation duct 100 having a three-dimensional shape including at least one curved surface, is formed by bending the core material 20 along the unfolded shape.

Hereinafter, the method of manufacturing the vacuum insulating material to form the three-dimensional vacuum insulation duct 100 according to the present embodiment will be described sequentially with reference to FIG. 1.

First, a metal wire 10 disposed in a certain pattern is prepared, as shown in FIG. 2(a), and the wire 10 is bonded to a core material 20 to provide a plate-shaped wire bonding structure 30, as shown in FIG. 2(b) (S100).

The core material 20 is preferably prepared by mixing a metal or glass with an epoxy resin as a binder, and the binder is not particularly limited as long as the binder can be used as a metal or glass binder.

It is desirable that an adsorbent (not shown) configured to absorb gas components be provided in the core material 20. The adsorbent is not particularly limited as long as it is possible to adsorb gas in the core material 20. More specifically, the adsorbent may be made of any one selected from the group consisting of activated carbon, silica gel, aluminum oxide, molecular sieves, zeolite, calcium oxide, barium oxide, calcium chloride, magnesium oxide, magnesium chloride, iron, zinc, a barium-lithium alloy, and a zirconium-based alloy.

Meanwhile, in preparing the metal wire 10 disposed in a certain pattern, as described above, a frame 12 may be applied such that the pattern of the wire 10 is maintained in a fixed state, as shown in FIG. 3.

In other words, the frame 12 extends so as to have a predetermined length corresponding to the length of the core material 20 in a width direction, and a plurality of wires 10 is connected to the frame 12 at intervals. As a result, when bonding the wires 10 to the core material 20 (see FIG. 2(b)), the wires 10 are bonded to the core material 20 together with the frame 12, thereby preventing movement during a vacuum insulation material forming process such that the pattern of the wire 10 can be fixed and maintained.

Subsequently, a processed core material 40 including the wire 10 is separated from the wire bonding structure 30 where the wire 10 is bonded to the core 20 (S200).

That is, as shown in FIG. 2(c), the plate-shaped wire bonding structure 30 is blanked along an unfolded shape using a press die 1 to form a three-dimensional duct, and, as shown in FIG. 2(d), the processed core material 40 formed in the unfolded shape is separated from the wire bonding structure 30.

Since the separated processed core material 40 includes the metal wire 10 and is formed in the unfolded shape (see FIG. 2(d), it is possible to improve the rigidity of the vacuum insulation material. In addition, when the processed core material 40 is processed along the unfolded shape, it is possible to realize a three-dimensional duct.

Subsequently, as shown in FIG. 2(e), the processed core material 40 is sealed and vacuum-treated using a cladding material 50 (S300).

That is, since the processed core material 40 is sealed and vacuum-treated with each of the top and the bottom of the processed core material 40 facing the cladding material 50, the cladding material 50 may wrap the exterior and the interior of the finally formed vacuum insulation duct 100.

More preferably, the cladding material 50 may be made of polyolefin coated with a metal selected from the group consisting of aluminum, gold, silver, copper, nickel, cobalt, chromium, and tin. When the cladding material 50 made of polyolefin with a metal deposited thereon is used, the gas barrier property of the cladding material 50 may be further improved, thereby enabling the vacuum state of the vacuum insulation material to be maintained for a long time.

When a vacuum insulation material is formed such that the cladding material 50 wraps the top and the bottom of the processed core material 40, as shown in FIG. 2(f), the processed core material 40 is bent, as shown in FIG. 2(g), to form a vacuum insulation duct 100 having at least one curved surface, i.e., a three-dimensional shape, as shown in FIG. 2(h) (S400).

At this time, when the processed core material 40 is bent (see FIG. 2(g)), the processed core material 40 is bent along the unfolded shape after being wrapped with the cladding material 50 in step S300, whereby the vacuum insulation duct 100 may be formed with the cladding material 50 wrapping the exterior and the interior thereof.

As a result, in this embodiment, the bonding structure 30 is provided by bonding the metal wire 10 disposed in a certain pattern to the plate-shaped core material 20, the bonding structure 30 is blanked using the press die 1 to separate the processed core material 40 in the unfolded shape, the top and the bottom of the processed core material 40 are sealed with the cladding material 50 and vacuum-treated, and bending is performed along the unfolded shape to form a vacuum insulation duct 100 in a three-dimensional shape, thereby enabling processing of the vacuum insulation material into a three-dimensional shape, and the rigidity of the vacuum insulation material may be improved by processing the vacuum insulation duct 100 having the metal wire 10 inserted therein.

Meanwhile, as shown in FIG. 4, in this embodiment, a cover 60 processed into a shape corresponding to the shape of the vacuum insulation duct 100 so as to prevent damage to the cladding material 50 may be mounted to an outer circumferential surface of the vacuum insulation duct 100 (S500).

More specifically, a cover 60 made of a thermoplastic material and formed into the same shape as the vacuum insulation duct 100 with a three-dimensional shape is mounted to each of one side and the other side of the vacuum insulation duct 100, thereby preventing damage to the cladding material 50 wrapping the exterior of the vacuum insulation duct 100.

Here, the cover 60 may be formed by molding low-density polyethylene (LDPE) through a molding process so as to have the same shape as the vacuum insulation duct 100; however, the above-mentioned material of the cover 60 is only an example, and other thermoplastic materials may be used.

Therefore, in this embodiment, it is possible to prevent damage to the cladding material 50 by mounting the cover 60 to the outer circumferential surface of the three-dimensional vacuum insulation duct 100, thereby preventing deterioration of the thermal insulation performance of the vacuum insulation material and improving the thermal insulation performance of, for example, a vehicle seat ventilation system to which the vacuum insulation duct 100 is applied.

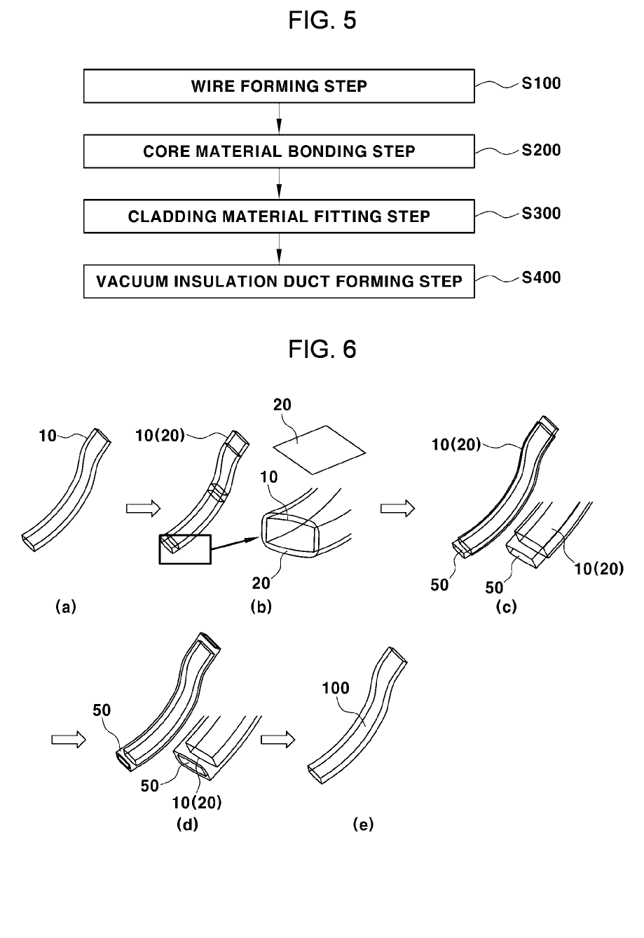

FIGS. 5 and 6 are views showing a method of manufacturing a vacuum insulating material according to another embodiment of the present disclosure in sequence.

Generally, a vacuum insulation material is a high-efficiency insulation material with low thermal conductivity, and may be produced into various plate shapes by adjusting the size and thickness of a core material provided therein.

That is, a general vacuum insulating material may be manufactured by wrapping the top and the bottom of a porous core material cut into a plate shape with a thin sheet-shaped cladding material to seal the porous core material and performing vacuum treatment to form an internal vacuum space.

However, the main component of the core material is glass fiber, and the main component of the cladding material is aluminum, both of which are prone to deformation and damage due to external force. This may lead to damage to the vacuum structure in the cladding material, resulting in a decrease in insulation performance, and therefore it is necessary to ensure the rigidity of the vacuum insulation material.

In addition, due to limitations in forming technology, the core material and the cladding material can only be formed into plate-like shapes, making it difficult to realize three-dimensional shapes such as a duct.

In the present embodiment, a core material 20 including a metal wire 10 is prepared in order to enhance rigidity of the vacuum insulation material and to form the vacuum insulation material into three-dimensional shapes. Since the core material 20 is processed in an unfolded shape, a vacuum insulating material, such as a vacuum insulation duct 100 having a three-dimensional shape including at least one curved surface, is formed by bending the core material 20 along the unfolded shape.

Hereinafter, a method of manufacturing a vacuum insulating material to form a three-dimensional vacuum insulation duct 100 according to the present embodiment will be described sequentially with reference to FIG. 5.

First, as shown in FIG. 6(a), a metal wire 10 is formed into a shape including one or more curved surfaces, e.g., a three-dimensional duct shape (S100).

Subsequently, as shown in FIG. 6(b), a core material 20 is bonded to the exterior of the duct-shaped wire 10 so as to wrap around the duct-shaped wire 10 (S200).

The core material 20 is preferably prepared by mixing a metal or glass with an epoxy resin as a binder, and the binder is not particularly limited as long as the binder can be used as a metal or glass binder.

It is desirable that an adsorbent (not shown) configured to absorb gas components be provided in the core material 20. The adsorbent is not particularly limited as long as it is possible to adsorb gas in the core material 20. More specifically, the adsorbent may be made of any one selected from the group consisting of activated carbon, silica gel, aluminum oxide, molecular sieves, zeolite, calcium oxide, barium oxide, calcium chloride, magnesium oxide, magnesium chloride, iron, zinc, a barium-lithium alloy, and a zirconium-based alloy.

Subsequently, as shown in FIGS. 6(c) and 6(d), a cladding material 50 is fitted on each of the interior and the exterior of the duct-shaped wire 10 including the core material 20 (S300), and the cladding material 50 is sealed and vacuum-treated so as to wrap around the core material 20 including the wire 10, thereby forming a three-dimensional vacuum insulation duct 100 with the cladding material 50 formed on each of the interior and the exterior thereof, as shown in FIG. 6(e) (S400).

Therefore, in this embodiment, a metal wire 10 formed into a three-dimensional shape such as a duct is wrapped with a core material 20, a cladding material 50 is fitted on each of the interior and the exterior of the core material 20 including the wire 10, and sealing and vacuum treatment are performed to form a vacuum insulation duct 100 in a three-dimensional shape, thereby enabling processing of a vacuum insulation material in a three-dimensional shape through the wire 10 and improving the rigidity of the vacuum insulation material through processing of the vacuum insulation duct 100 with the metal wire 10 inserted therein.

Meanwhile, in this embodiment, a cover 60 processed into a shape corresponding to the shape of the vacuum insulation duct 100 so as to prevent damage to the cladding material 50 may be mounted to an outer circumferential surface of the vacuum insulation duct 100 (S500) (see FIG. 4).

More specifically, a cover 60 made of a thermoplastic material and formed into the same shape as the vacuum insulation duct 100 with a three-dimensional shape is mounted to each of one side and the other side of the vacuum insulation duct 100, thereby preventing damage to the cladding material 50 wrapping the exterior of the vacuum insulation duct 100.

Here, the cover 60 may be formed by molding low-density polyethylene (LDPE) through a molding process so as to have the same shape as the vacuum insulation duct 100; however, the above-mentioned material of the cover 60 is only an example, and other thermoplastic materials may be used.

Therefore, in this embodiment, it is possible to prevent damage to the cladding material 50 by mounting the cover 60 to the outer circumferential surface of the three-dimensional vacuum insulation duct 100, thereby preventing deterioration of the thermal insulation performance of the vacuum insulation material and improving the thermal insulation performance of, for example, a vehicle seat ventilation system to which the vacuum insulation duct 100 is applied.

As is apparent from the foregoing, in the present disclosure, a metal wire disposed in a certain pattern is bonded to a plate-shaped core material, the core material is blanked using a press die to separate the core material in an unfolded shape, the top and the bottom of the core material in the unfolded shape are sealed with a cladding material and vacuum-treated, and bending is performed along the unfolded shape to form a vacuum insulation duct in a three-dimensional shape, and therefore the present disclosure has the effect of improving the rigidity of the vacuum insulation duct having the metal wire inserted therein by processing the vacuum insulation duct.

In addition, in the present disclosure, a cover made of a thermoplastic material and formed into the same shape as the three-dimensional vacuum insulation duct is mounted to an outer circumferential surface of the vacuum insulation duct, and therefore the present disclosure has the effect of preventing damage to the cladding material.

Consequently, the present disclosure has the effect of preventing deterioration of the thermal insulation performance of the vacuum insulation material and improving the thermal insulation performance of a vehicle seat ventilation system to which the vacuum insulation duct is applied.

Although the present disclosure has been described with reference to the embodiment(s) shown in the drawings, which are merely illustrative, those skilled in the art will understand that various modifications are possible therefrom and all or some of the embodiment(s) may be selectively combined. Therefore, the real technical protection scope of the present disclosure is defined by the technical idea of the appended claims.

What is claimed is:

1. A method of manufacturing a vacuum insulation material, the method comprising:
a wire bonding step of providing a wire bonding structure by bonding a metal wire disposed in a given pattern to a core material thereby generating a processed core material comprising the wire;
a core material separation step of separating the processed core material from the wire bonding structure;
a sealing and vacuum treatment step of sealing and vacuum treating the processed core material by wrapping with a cladding material; and
a vacuum insulation duct forming step of bending the processed core material wrapped with the cladding material by a sealing and vacuum treatment to form a vacuum insulation duct comprising at least one curved surface.

2. The method according to claim 1, wherein, in the wire bonding step, the wire along with a frame is bonded to the core material while the wire is fixed and the given pattern of the wire is maintained by way of the frame.

3. The method according to claim 1, wherein, in the core material separation step, the processed core material in an unfolded shape is separated from the wire bonding structure by blanking.

4. The method according to claim 3, wherein in the vacuum insulation duct forming step, the processed core material wrapped with the cladding material is bent along the unfolded shape to form the vacuum insulation duct.

5. The method according to claim 1, wherein, in the sealing and vacuum treatment step, sealing and vacuum treatment are performed to a top and a bottom of the processed core material that are facing the cladding material such that an exterior and an interior of the vacuum insulation duct are wrapped by the cladding material.

6. The method according to claim 1, further comprising a cover mounting step of mounting a cover, processed to correspond in shape to the vacuum insulation duct, to an exterior of the vacuum insulation duct.

7. A method of manufacturing a vacuum insulation material, the method comprising:
a wire forming step of forming a metal wire into a duct shape comprising at least one curved surface so as to form a duct-shaped wire;
a core material bonding step of bonding a core material to an exterior of the duct-shaped wire so as to wrap around the wire;
a cladding material fitting step of fitting a cladding material on the interior and the exterior of the duct-shaped wire wrapped by the core material; and
a vacuum insulation duct forming step of sealing and vacuum treating the cladding material to form a vacuum insulation duct.

8. The method according to claim 7, further comprising a cover mounting step of mounting a cover processed to correspond in shape to the vacuum insulation duct to an exterior of the vacuum insulation duct.
